(19) United States
(12) Patent Application Publication
(10) Pub. No.: US 2024/0269032 A1
(43) Pub. Date: Aug. 15, 2024

(54) Roller Apparatus

(71) Applicant: Rolleround LLC, New Providence, NJ (US)

(72) Inventor: David Snyder, New Providence, NJ (US)

(21) Appl. No.: 18/490,159

(22) Filed: Oct. 19, 2023

Related U.S. Application Data
(60) Provisional application No. 63/445,385, filed on Feb. 14, 2023.

(51) Int. Cl. A61H 15/00

(52) U.S. Cl. CPC A61H 15/0092; A61H 2015/0014

(57) ABSTRACT

A roller apparatus including a frame and a rotatable roller. A roller is rotatably mounted on the front portion of the frame. A handle extends from either side of the frame. During use, the hand of the user can be positioned below the rear portion of the frame and extend through opening in the frame adjacent the handle. The handle can be grasped by the user. A bottom surface of the rear portion of the frame contacts the wrist, hand or arm of the user. The roller contacts an area of the portion of a person or animal to be massaged having the advantage that additional leverage is applied from additional pressure applied to the roller from the user's wrist.

### BACKGROUND OF THE INVENTION

### Field of the Invention

The present invention relates generally to a roller apparatus which can be used for massaging muscles and in particular to a frame mounting a rotatable roller and providing leverage during use to increase pressure applied to the rotatable roller during use.

### Description of Related Art

It is known that foam rollers have been used for massaging muscles. Foam rollers having a cylinder of firm foam are placed against or underneath body part. The foam rollers are rolled against muscles and fascia to loosen areas that feel tight, prevent injuries, relieve muscle tightness, soreness, and inflammation, and increase joint range of motion.

CN 215652485 describes a massage roller frame including a bracket body in which the main body is a gap rectangle. A clamping part of the frame is movably connected to a roller device. The roller device is a foam shaft. During use, a leg is placed on the foam shaft and it makes use of its own gravity to reach the massage effect.

US Patent Application Publication No. 20180042806 describes a massage device including a foam roller connected to a hand grip by a frame. An alternate hand grip can angle out 90 degrees from the hand grip. A user holds the device with either the hand grip or the alternate hand grip and places the roller on the person at the area of the body that needs massaged. The user will then roll the foam roller on that person's body to provide the proper massage.

It is desirable to provide an improved roller apparatus which is handheld to easily and expeditiously provide selected amounts of pressure to the roller having the advantage of additional leverage resulting from additional pressure applied to the roller from the user's wrist.

### SUMMARY OF THE INVENTION

The present invention relates to roller apparatus including a frame and a rotatable roller. The frame having a front portion, middle portion and rear portion. The middle portion of the frame being between the front portion and the rear portion. A roller is rotatably mounted on the front portion of the frame. A handle extends from either side of the frame at the middle portion of the frame. In one embodiment, the handle is positioned centrally between the front portion and the rear portion of the frame. Alternatively, the handle is positioned closer to the front portion or closer to the rear portion of the frame.

During use, the hand of the user can be positioned below the rear portion of the frame and extend through opening in the frame adjacent the handle. The handle can be grasped by the user. A bottom surface of the rear portion of the frame contacts the wrist, hand or arm of the user. The roller contacts an area of the portion of a person to be massaged. The person can be the user of the roller apparatus or another person. Alternatively, the roller apparatus can be used by a person to exert pressure of the roller on an area of an animal to be massaged. In one embodiment, the animal to be massaged is a horse. The roller can be rolled against the portion of the person or animal to be massaged. The rear portion provides leverage of the frame to adjust the pressure applied by the roller to the area contacted by the roller. The apparatus of the present invention has the advantage that it can effectively be used with one hand while still providing substantial force due to providing leverage from the user's wrist.

In one embodiment, the rear portion of the frame laterally extends between sides of the frame. In another embodiment, the rear portion of the frame extends radially or has a semi— circular shape between sides of the frame. In one embodiment, the length of the rear portion is the same as the length of the front portion. In an alternative embodiment, the length of the rear portion is smaller or larger than the length of the front portion.

In one embodiment, a first roller is rotatably mounted at a first end and a second roller is rotatably mounted at a second end of a frame in a double roller configuration. Each of the first and second rollers can have a cylindrical shape. The first and second rollers can have the same or different dimensions. In one embodiment one of the rollers is shorter in length than the other roller. In one embodiment, one of the rollers can have a smaller width or circumference than other roller. The rollers can be formed of the same or different materials. One of the first and second rollers can be rolled against the portion of the person or animal to be massaged. The other of the first and second rollers contacts the wrist, hand or arm of the user for providing leverage of the frame to adjust the pressure applied by the roller rolled against the portion of the person or animal to be massaged.

In one embodiment, one or more rollers are interchangeably coupled to the frame. The rollers can be formed of firm foam or low density and low firmness foam. Examples of materials for the rollers include plastic, expanded polyethylene (EPE) foam, polyethylene foam, thermoplastic polyurethane (TPU) and ethylene vinyl acetate (EVA).

The invention will be more fully described by reference to the following drawings.

### BRIEF DESCRIPTION OF THE DRAWINGS

FIG. 1 is a bottom schematic view of a roller apparatus in accordance with the teachings of the present invention.

FIG. 2 is a front and top perspective schematic view of the roller apparatus shown in FIG. 1 during use.

FIG. 3. is a top perspective schematic view of a roller apparatus during use.

FIG. 4 is a top perspective schematic view of a roller apparatus during use.

FIG. 5 is a top perspective schematic view of a roller apparatus during use.

FIG. 6 is a top perspective schematic view of a roller apparatus during use.

FIG. 7 is a top perspective schematic view of the roller apparatus shown in FIG. 6 during use upon reversal of the positioning of the rollers.

FIG. 8 is a bottom schematic view of a roller apparatus in accordance with the teachings of the present invention.

Embodiments of the present disclosure and their advantages are best understood by referring to the detailed description that follows. It should be appreciated that the figures may not be necessarily drawn to scale.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

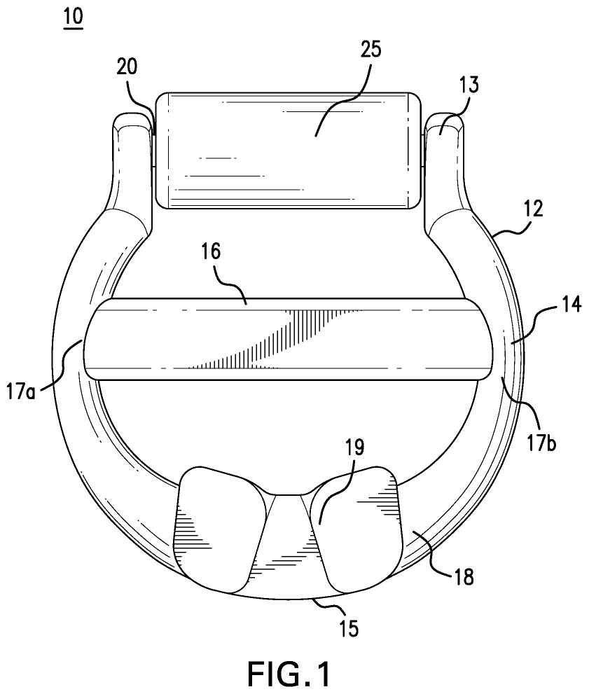

FIG. 1 illustrates roller apparatus 10 in accordance with the teachings of the present invention. Roller apparatus 10 includes frame 12. Frame 12 includes front portion 13, middle portion 14 and rear portion 15. Middle portion 14 is positioned between front portion 13 and rear portion 15. Rear portion 15 and middle portion 14 of frame 12 can have a rounded, circular or semi-circular shape. Frame 12 can be formed of rigid or semi-rigid plastic. For example, frame 12 can be formed of polyvinyl chloride (PVC). Alternatively, frame 12 could be formed of wood or metal.

Handle 16 extends between side 17a and side 17b at middle portion 14 of frame 12. Handle 16 can extend laterally between side 17a and side 17b. Handle 16 can be positioned centrally between front portion 13 and rear portion 15 of frame 12. Handle 16 can be integral with frame 12.

Bottom surface 18 of rear portion 15 can include contact area 19. Contact area 19 can include a foam or flexible material for comfort during contact with a user body part during use.

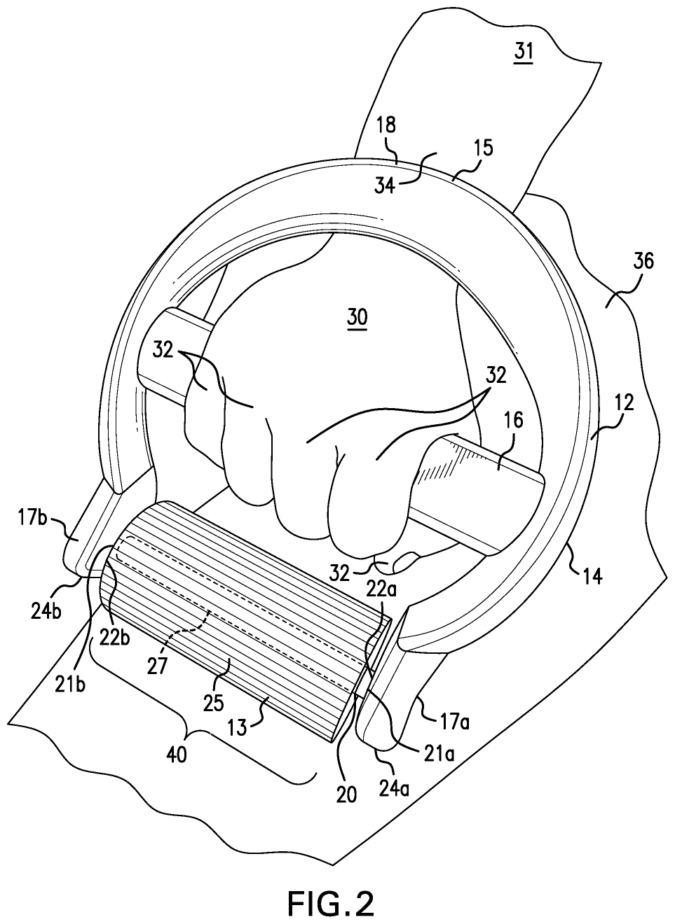

Front portion 13 of frame 12 can be open between side 17a and side 17b. Frame 12 can have a U-shape. Axle 20 extends between side 17a and side 17b at front portion 13 of frame 12. End 21a of axle 20 can be received in aperture 22a of extension 24a of frame 12 as shown in FIG. 2. End 21b of axle 20 can be received in aperture 22b of extension 24b of frame 12. Roller 25 is received over axle 20. Roller 25 can have aperture 27 extending along the length of roller 25 for receiving axle 20. Roller 25 can freely rotate around axle 20. Alternatively, axle 20 is rotatable within apertures 22a, 22b. Roller 25 extends over axle 20 and is attached to axle 20. Roller 25 can be rotated by axle 20. In one embodiment, roller 25 is integral with axle 20. Roller 25 can have a cylindrical shape. Roller 25 can be formed of a firm foam or low density and low firmness foam. Suitable materials for roller 25 include expanded polyethylene (EPE) foam, polyethylene foam, polyurethane (TPU) and ethylene vinyl acetate (EVA). Frame 12 includes opening 28 extending between front portion 13 and handle 16. Frame 12 includes opening 29 extending between rear portion 15 and handle 16.

During use, hand 30 of user 31 can be received below bottom surface 18 of rear portion 15 of frame 12 and extend through opening 29 to grasp handle 16. Handle 16 can be grasped by one or more digits 32 of user 31. One or more digits of user 31 can extend into opening 28. Bottom surface 18 of rear portion 15 of frame 12 contacts wrist 34 of user 31. Roller 25 contacts contact area 40. For example, contact area 40 can be leg 36 of user 31. It will be appreciated that contact area 40 can be any area of the body of user 31 or of a person or animal other than user 31 to be massaged. Roller 25 can be rolled against contact area 40. Contact of wrist 34 with rear portion 15 of frame 12 provides leverage of frame 12 in order to adjust pressure applied by roller 25 to contact area 40. In one embodiment, the pressure applied by roller 25 is increased by applying pressure by the wrist, hand or arm to rear portion 15 of frame 12. It will be appreciated that frame 12 can be easily flipped and can be used with a hand of a user received below either surface of frame 12.

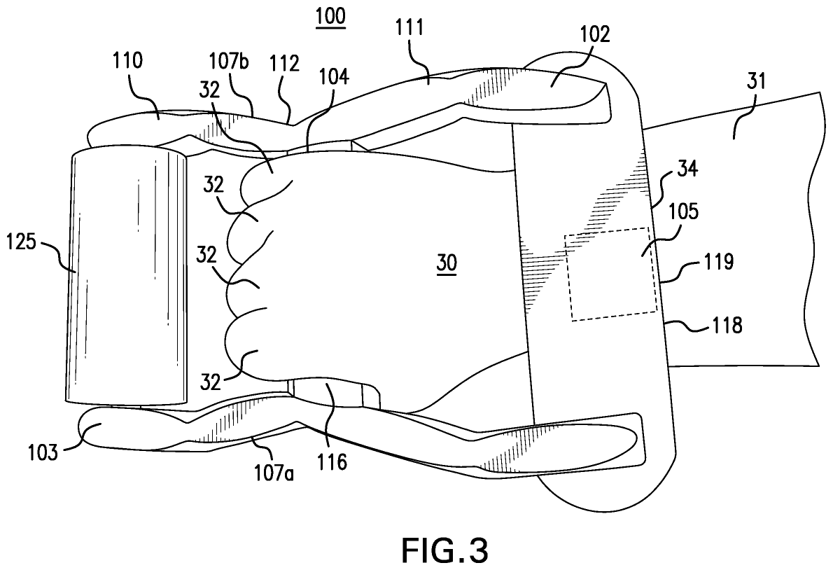

FIG. 3 illustrates an embodiment of roller apparatus 100. Roller apparatus 100 includes frame 102. Frame 102 includes front portion 103, middle portion 104 and rear portion 105. Middle portion 104 is positioned between front portion 103 and rear portion 105. Rear portion 105 extends laterally between side 107a and side 107b. Rear portion 105 can extend past middle portion 104. Rear portion 105 can have a length which is longer than a distance between side 107a and side 107b of front portion 103. Middle portion 104 can include front adjoining portion 110 and rear adjoining portion 111 coupled at central adjoining portion 112. Front adjoining portion 110 and rear adjoining portion 111 can have a curved shaped with front adjoining portion 110 having a smaller length than rear adjoining portion 111.

Handle 116 extends between side 107a and side 107b at middle portion 104 of frame 102. Handle 116 can extend laterally between side 107a and side 107b. Handle 116 can be positioned nearer to front portion 103 than rear portion 105 of frame 102. Handle 116 can be integral with frame 102.

Bottom surface 118 of rear portion 105 can include contact area 119. Contact area 119 can include a foam or flexible material for comfort during contact with a user body part during use.

During use, hand 30 of user 31 can be received below bottom surface 118 of rear portion 105 of frame 102. Handle 116 can be grasped by one or more digits 32 of user 31. Bottom surface 118 of rear portion 105 of frame 102 contacts wrist 34 of user 31. Contact of wrist 34 with rear portion 105 of frame 102 provides leverage of frame 102 in order to adjust pressure applied by roller 125 to the desired contact area. In one embodiment, the pressure applied by roller 125 is increased by applying pressure by the wrist, hand or arm to rear portion 105 of frame 102. It will be appreciated that frame 102 can be easily flipped and can be used with a hand of a user received below either surface of frame 12.

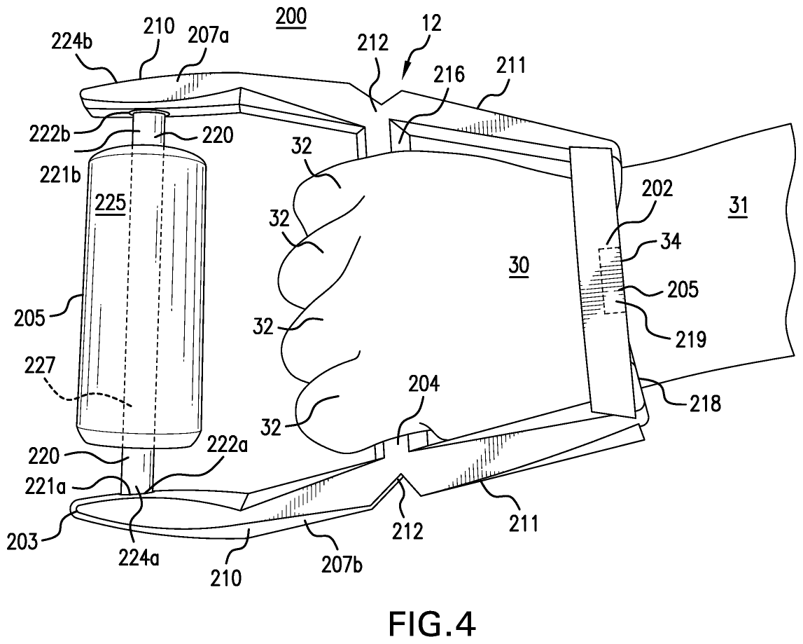

FIG. 4 illustrates an embodiment of roller apparatus 200. Roller apparatus 200 includes frame 202. Frame 202 includes front portion 203, middle portion 204 and rear portion 205. Middle portion 204 is positioned between front portion 203 and rear portion 205. Rear portion 205 extends laterally between side 207a and side 207b. Rear portion 205 can have a length which is shorter than a distance between side 207a and side 207b of front portion 203. Middle portion 204 can include front adjoining portion 210 and rear adjoining portion 211 coupled at central adjoining portion 212. Front adjoining portion 210 and rear adjoining portion 211 can have a curved shaped or angled shape. Front adjoining portion 210 can have a larger length than rear adjoining portion 211.

Handle 216 extends between side 207a and side 207b at middle portion 204 of frame 202. Handle 216 can extend laterally between side 207a and side 207b. Handle 216 can be positioned nearer to front portion 203 than rear portion 205 of frame 202. Handle 216 can be integral with frame 202.

Bottom surface 218 of rear portion 205 can include contact area 219. Contact area 219 can include a foam or flexible material for comfort during contact with a user body part during use.

Axle 220 extends between side 207a and side 207b at front portion 203 of frame 202. End 221a of axle 220 can be received in aperture 222a of extension 224a of frame 202. End 221b of axle 220 can be received in aperture 222b of extension 224b of frame 202. Roller 225 is received over axle 220. Roller 225 can have aperture 227 extending along the length of roller 225 for receiving axle 220. Roller 225 can freely rotate around axle 220.

During use, hand 30 of user 31 can be positioned below bottom surface 218 of rear portion 205 of frame 202. Handle 216 can be grasped by one or more digits 32 of user 31. Bottom surface 218 of rear portion 205 of frame 202 contacts wrist 34 of user 31. Contact of wrist 34 with rear portion 205 of frame 202 provides leverage of frame 202 in order to adjust pressure applied by roller 225 to the desired contact area. In one embodiment, the pressure applied by roller 225 is increased by applying pressure by the wrist, hand or arm to rear portion 205 of frame 202 It will be appreciated that the frame 202 can be easily flipped and can be used with a hand of a user received below either surface of frame 202.

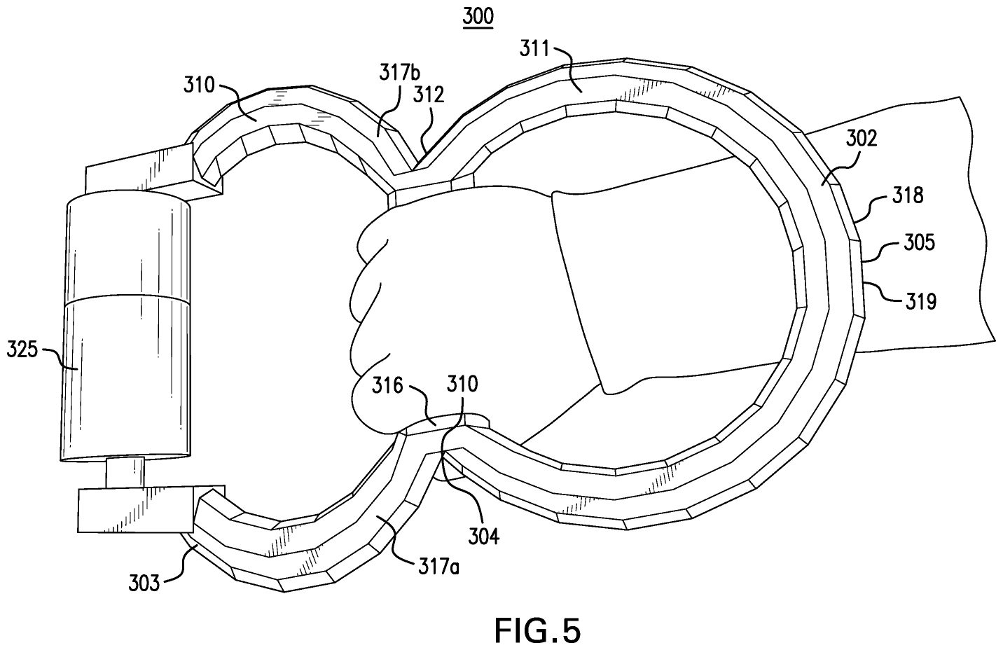

FIG. 5 illustrates roller apparatus 300 in accordance with the teachings of the present invention. Roller apparatus 300 includes frame 302. Frame 302 includes front portion 303, middle portion 304 and rear portion 305. Middle portion 304 is positioned between front portion 303 and rear portion 305. Middle portion 304 can include front adjoining portion 310 and rear adjoining portion 311 coupled at central adjoining portion 312. Front adjoining portion 310 and rear adjoining portion 311 each having a curved shape. Front adjoining portion 310 can have a larger radius of the curve than rear adjoining portion 311. Rear portion 305 of frame 302 can have a rounded, circular or semi-circular shape. Contact of wrist 34 with rear portion 305 of frame 302 provides leverage of frame 302 in order to adjust pressure applied by roller 325 to the desired contact area. In one embodiment, the pressure applied by roller 325 is increased by applying pressure by the wrist, hand or arm to rear portion 305 of frame 302. It will be appreciated that the frame 302 can be easily flipped and can be used with a hand of a user received below either surface of frame 302.

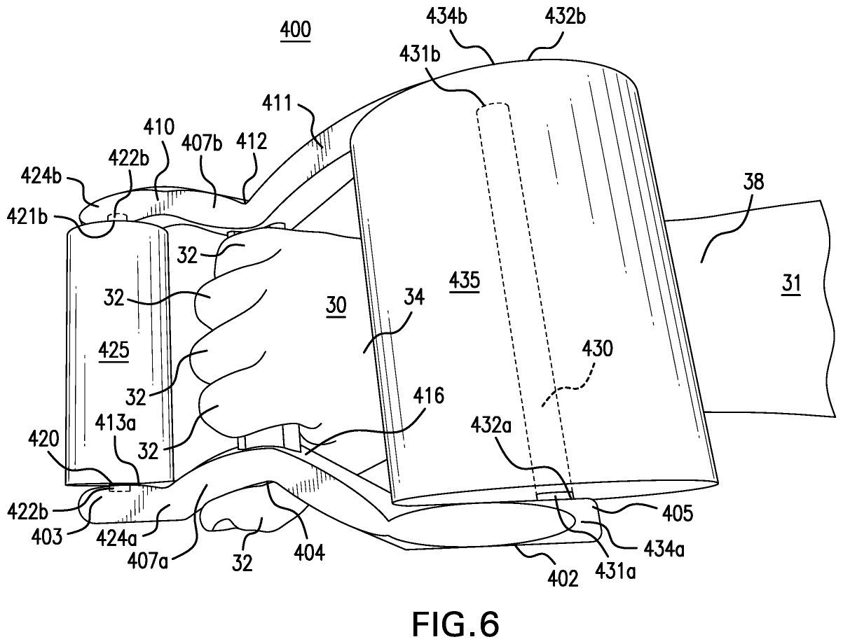

FIG. 6 illustrates roller apparatus 400 in accordance with the teachings of the present invention. Roller apparatus 400 includes frame 402. Frame 402 includes end portion 403, middle portion 404 and end portion 405. Middle portion 404 is positioned between end portion 403 and end portion 405.

Middle portion 404 can include end adjoining portion 410 and end adjoining portion 411 coupled at joining portion 412. End adjoining portion 410 and end adjoining portion 411 can have a curved shaped or angled shape. End adjoining portion 410 has a larger length than end adjoining portion 411.

Handle 416 extends between side 407a and side 407b at joining portion 412 of middle portion 404. Handle 416 can extend laterally between side 407a and side 407b. Handle 416 can be positioned closer to end portion 403 than end portion 405 of frame 402. Handle 416 can be integral with frame 402.

Axle 420 extends between side 407a and side 407b at end portion 403 of frame 402. End 421a of axle 420 can be received in aperture 422a of extension 424a of frame 402. End 421b of axle 420 can be received in aperture 422b of extension 424b of frame 402. Roller 425 is received over axle 420. Roller 425 can have aperture 427 extending along the length of roller 425 for receiving axle 420. Roller 425 can freely rotate around axle 420.

Axle 430 extends between side 407a and side 407b at end portion 405 of frame 402. End 431a of axle 430 can be received in aperture 432a of extension 434a of frame 402. End 431b of axle 430 can be received in aperture 432b of extension 434b of frame 402. Roller 435 is received over axle 430. Roller 435 can have aperture 437 extending along the length of roller 435 for receiving axle 430. Roller 435 can freely rotate around axle 430.

Roller 25 and roller 435 can have a cylindrical shape. Roller 425 and roller 435 can have the same or different dimensions. In one embodiment roller 425 is shorter in length than roller 435. Roller 425 can have a smaller width or circumference than roller 435. Roller 425 and roller 435 can be formed of the same or different materials such as for example a firm foam or low density and low firmness foam. Suitable materials for roller 425 and roller 435 include expanded polyethylene (EPE) foam, polyethylene foam, thermoplastic polyurethane (TPU) and ethylene vinyl acetate (EVA).

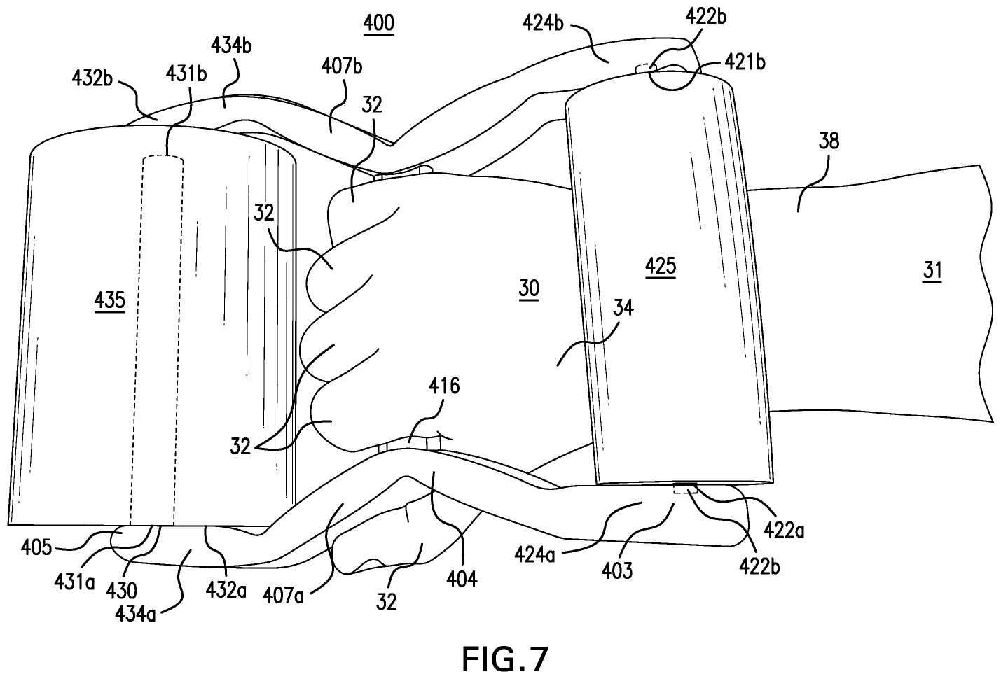

During use, hand 30 of user 31 can be received below end portion 405 of frame 402. Handle 416 can be grasped by one or more digits 32 of user 31. Roller 435 contacts wrist 34 and arm 38 of user 31. Contact of wrist 34 and arm 38 with roller 435 provides leverage of frame 402 in order to adjust pressure applied by roller 435. Alternatively, hand 30 of user 31 can be received below end portion 403 of frame 402 as shown in FIG. 7. Handle 416 can be grasped by one or more digits 32 of user 31. Roller 425 contacts wrist 34 of user 31. Contact of wrist 34 with roller 425 provides leverage of frame 402 in order to adjust pressure applied by roller 425. In one embodiment, the pressure applied by roller 425 is increased by applying pressure by the wrist, hand or arm to rear portion 405 of frame 402. It will be appreciated that the frame 402 can be easily flipped and can be used with a hand of a user received below either surface of frame 402.

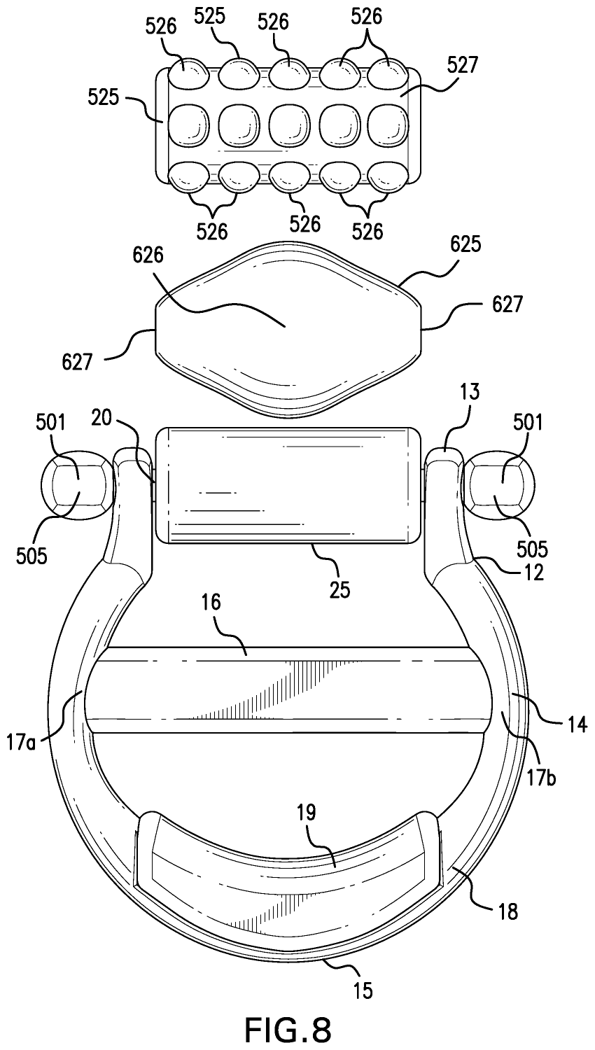

FIG. 8 illustrates roller apparatus 10 including coupling member 501 for interchangeably coupling roller 25, roller 525 or roller 625 to frame 12. In one embodiment, coupling member 501 can screw onto axle 20 of roller 25, roller 525 or roller 625. Coupling member 501 can include indentions 505 for receiving one or more digits of a user. Roller 525 can include a plurality of protrusions 526 extending from outer surface 527. Roller 625 can have an extending middle portion 626. Middle portion 626 has a larger diameter than end portions 627 of roller 625. Roller 625 can have a spherical polyhedron shape. It will be appreciated that roller apparatus 10 and coupling member 501 can be used with various sizes and shapes of rollers.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A roller apparatus comprising:
a frame, the frame including a front portion and a rear portion;
a roller rotatably mounted on the front portion of the frame; and
a handle extending from a first side of the frame to a second side of the frame, the handle being positioned between the front portion and the rear portion of the frame.

2. The roller apparatus of claim 1 wherein the frame includes a first opening between the front portion of the frame and the handle and a second opening between the rear portion of the frame and the handle.

3. The roller apparatus of claim 2 wherein the handle is configured to be grasped by a hand of user received below a bottom surface of the rear portion and extending through the second opening and the rear portion of the frame contacts a wrist, hand or arm of the user to provide leverage of the frame to adjust pressure applied to the roller.

4. The roller apparatus of claim 3 wherein the frame is configured to allow a hand of the user to extend through the first opening to grasp the handle with one or more digits of the user extending into the first opening.

5. The roller apparatus of claim 1 wherein the handle is positioned centrally between the front portion and the rear portion of the frame.

6. The roller apparatus of claim 1 wherein the handle is positioned closer to the front portion or the rear portion of the frame.

7. The roller apparatus of claim 1 wherein the handle is integral with the frame.

8. The roller apparatus of claim 1 wherein the rear portion and the middle portion of the frame have a rounded, circular or semi-circular shape.

9. The roller apparatus of claim 1 wherein the front portion of the frame is open between a first side and a second side, an axle extends between the first side and the second side at the front portion of the frame, a first end of the axle is received in a first aperture in the first side of the frame and a second end of the axle is received in second aperture in the second side of the frame, the roller having an aperture extending along the length of the roller, the axle received in the aperture of the roller, wherein the roller freely rotates around the axle during use.

10. The roller apparatus of claim 9 further comprising a least one coupling member received at an end of the axle extending through the first or second aperture of the frame, the coupling member being coupled or removed from the end of the axle for interchangeably coupling the roller to the frame.

11. The roller apparatus of claim 1 wherein the front portion of the frame is open between a first side and a second side, an axle extends between the first side and the second side at the front portion of the frame, a first end of the axle is received in a first aperture in the first side of the frame and a second end of the axle is received in second aperture in the second side of the frame, the roller extending around or integral with the axle, the axle is rotatable within the first and second apertures, wherein the roller is rotated by the axle during use.

12. The roller apparatus of claim 11 further comprising a least one coupling member received at an end of the axle extending through the first or second aperture of the frame, the coupling member being coupled or removed from the end of the axle for interchangeably coupling the roller to the frame.

13. The roller apparatus of claim 1 wherein the roller has a cylindrical shape.

14. The roller apparatus of claim 1 wherein the roller includes a plurality of protrusions extending from an outer surface of the roller or the roller includes a middle portion having a larger diameter than the end portions of the roller.

15. The roller apparatus of claim of 1 wherein rear portion has a same length, longer length or shorter length than a distance between the first side and the second side of the front portion of the frame.

16. The roller apparatus of claim 1 wherein the middle portion includes a front adjoining portion and rear adjoining portion, the front adjoining portion and the rear adjoining portion having a curved shaped or angled shape, the front adjoining portion has a same length, longer length or shorter length than the length of the rear adjoining portion, and when the front adjoining portion and the rear adjoining portion having a curved shape, the front adjoining portion has a same radius of curve, longer radius of curve or shorter radius of curve than a radius of the rear adjoining portion.

17. The roller apparatus of claim 1 wherein the bottom surface of the rear portion 15 includes contact area, the contact area comprising a foam or flexible material.

18. A roller apparatus comprising:
a frame, the frame including a first end portion a second end portion;
a middle portion positioned between the first end portion and the second end portion;
a first roller rotatably mounted on the first end portion of the frame;
a second roller rotatably mounted on the second end portion of the frame; and
a handle extending from a first side of the frame to a second side of the frame, the handle being positioned between the front portion and the rear portion of the frame, wherein the first roller and the second roller have the same dimension or the first roller and the second roller have different lengths and different circumferences than each other, the first roller and the second roller comprised of the same or different materials

19. The roller apparatus of claim 18 wherein the middle portion includes a front adjoining portion and rear adjoining portion, the front adjoining portion and the rear adjoining portion having a curved shaped or angled shape, the front adjoining portion has a same length, longer length or shorter length than the length of the rear adjoining portion, and when the front adjoining portion and the rear adjoining portion having a curved shape, the front adjoining portion has a same radius of curve, longer radius of curve or shorter radius of curve than a radius of the rear adjoining portion.

20. A method for massaging a person or an animal comprising the steps of;
grasping a handle of a roller apparatus, said roller apparatus comprising a frame, the frame including a first end portion and a second end portion, at least one roller rotatably mounted on the first end portion or the second end portion of the frame, and the handle extending from a first side of the frame to a second side of the frame, the handle being positioned between the first end portion and the second end portion of the frame, the frame includes a first opening between the first portion of the frame and the handle and a second opening between the second end portion of the frame and the handle, the handle is configured to be grasped by a hand of user received below a bottom surface of the frame and extending into the first or the second opening;
contacting the bottom surface of the frame or the at least one roller rotatably mounted on the first end portion or the second end portion of the frame against a wrist, hand or arm of the user; and
rolling the at least one roller against a portion the person or animal, wherein the wrist, hand or arm of the user provides leverage of the frame to adjust pressure applied to the roller.
